(19) United States
(12) Patent Application Publication
(10) Pub. No.: US 2007/0043679 A1
(43) Pub. Date: Feb. 22, 2007

(54) N-tier license distribution

(75) Inventors: Tu Le, Irvine, CA (US); Derick Snyder, Buena Park, CA (US)

Correspondence Address: VENABLE LLP, P.O. BOX 34385, WASHINGTON, DC, 20043-9998, US

(73) Assignee: SAFENET, INC., Belcamp, MD (US)

(21) Appl. No.: 11/290,463

(22) Filed: Dec. 1, 2005

Related U.S. Application Data
(60) Provisional application No. 60/709,814, filed on Aug. 22, 2005.

(51) Int. Cl. G06Q 99/00

(52) U.S. Cl. 705/59

(57) ABSTRACT

A system and method for the issuance of software licenses through a tiered structure, whereby a software license is issued from a software developer to an end user through one or more intermediate layers of distribution. The system and method for doing so enforces a predefined security policy. In an embodiment of the invention, the security policy is defined by the security developer. The security policy may, for example, address who may use the software package, how many users there may be, an expiration date for use of the software, and/or specific features that may or may not be used by a particular user. The software developer first issues a license template to the next intermediate layer of distribution. This may be a software distributor, who then specifies one or more restrictions on the use of the software. This is done be articulating these restrictions in the license template, effectively “filling in” some or all of the template. Any such embellishment of the software license template must be in accordance with the security policy. In the final transaction, a final distributor transmits a completed software license to a user. At no time can an intermediate distributor issue a license or template that is less restrictive than what is dictated by the security policy, or less restrictive than the template given to the distributor.

This patent application claims priority to U.S. Provisional Patent Application 60/709,814, entitled “N-Tier License Distribution,” filed Aug. 22, 2005, which is incorporated herein by reference in its entirety.

### BACKGROUND OF THE INVENTION

1. Field of the Invention

The invention described herein relates to digital rights management.

2. Related Art

One of the long-standing problems in the software industry is that of piracy. A software developer creates a software package and, ideally, the software is used only by those parties who have purchased the software or who are otherwise authorized to use it. If the software is copied and used by others who are not authorized to use the software, the software developer may lose money.

Software piracy is traditionally controlled in part through a licensing arrangement. When a software package is purchased by a party, one or more licenses are granted to the buyer. Those who have a license may use the package. Those lacking a license generally cannot. Licensing is typically controlled by a central authority, such as the software developer. The developer makes a sale and issues one or more licenses with the software package. If a prospective customer wishes to purchase the software package, or if the customer has already purchased a package but wishes an additional license, the customer must deal with the software developer in seeking a license. This can be inconvenient. Under this arrangement there is only one source for software licenses. While a customer may go to a local distributor for hardware needs or other commodities, there may not be such an option in the case of software. Indeed, there may be only one source, nationally or internationally, for a software license.

In some cases, a software developer may have one or more intermediate software distributors. In such an arrangement, the intermediate distributor does not generate a software license. Rather, the distributor receives some number of licenses from the software developer and issues those licenses to parties receiving the software package. In this arrangement, the software developer loses a certain amount of control. The issuance of software licenses falls to the distributor, rather than the software developer itself. In the event that the developer chooses to give up such control to an intermediate distributor, security dictates that the intermediate distributor's actions fall under the control of some security policy. Ideally, the licenses would only be distributed to authorized parties, and would include, for example, only certain features that are authorized for use (e.g., purchased) by the licensees. This may not be the case where the intermediate distributor has the authority to distribute licenses. The intermediate distributor's enforcement of a security policy may be unreliable.

What is needed, therefore, is a system or method for software licensing, whereby a user has a local contact with which he may do business, while the ultimate software developer retains control over the licensing process, e.g., which parties receive a license, what features are granted to a specific licensee, and/or when a license expires. Moreover, the developer needs to be in a position to enforce a security policy regarding the software product.

### SUMMARY OF THE INVENTION

The invention described herein is a system and method for the issuance of software licenses through a tiered structure, whereby a software license is issued from a software developer to an end user through one or more intermediate layers of distribution. The system and method for doing so enforces a predefined security policy. In an embodiment of the invention, the security policy is defined by the security developer. The security policy may, for example, address who may use the software package, how many users there may be, an expiration date for use of the software, and/or specific features that may or may not be used by a particular user. The software developer first issues a license template to the next intermediate layer of distribution. This may be a software distributor, who then specifies one or more restrictions on the use of the software. This is done by articulating these restrictions in the license template, effectively “filling in” some or all of the template. Any such embellishment of the software license template must be in accordance with the security policy. In the final transaction, a final distributor transmits a completed software license to a user. At no time can an intermediate distributor issue a license or template that is less restrictive than what is dictated by the security policy, or less restrictive than the template given to the distributor.

Further embodiments, features, and advantages of the present invention, as well as the structure and operation of the various embodiments of the present invention, are described below with reference to the accompanying figures.

### BRIEF DESCRIPTION OF THE FIGURES

FIG. 1 illustrates the issuance of a software license from a developer to an end user, after the developer has received a server license from a server licensor, according to an embodiment of the invention.

FIG. 2 illustrates a developer passing a license template to a distributor, who then creates and sends a software license to an end user, according to an embodiment of the invention.

FIG. 3 illustrates a server licensor issuing server licenses to a plurality of software developers, according to an embodiment of the invention.

FIG. 4 illustrates a software developer issuing license templates to a plurality of distributors, according to an embodiment of the invention.

FIG. 5 illustrates a distributor passing software licenses to a plurality of end users, according to an embodiment of the invention.

FIG. 6 illustrates a software developer passing a license template to a distributor, which then passes on a license template to one or more subsequent distributors in sequence, according to an embodiment of the invention.

FIG. 7 is a flowchart illustrating the processing of a license request from an end user, according to an embodiment of the invention.

FIG. 8 is a flowchart illustrating in greater detail the step of binding and sending a license to an end user, according to an embodiment of the invention.

FIG. 9 is a flowchart illustrating the processing performed by the end user after receiving a license from a distributor, according to an embodiment of the invention.

FIG. 10 is a flowchart illustrating the processing at a distributor, after receiving a request from a lower level distributor for a license template, according to an embodiment of the invention.

FIG. 11 is a flowchart illustrating in greater detail the step of binding and sending a license template to a lower level distributor, according to an embodiment of the invention.

FIG. 12 is a flowchart illustrating the processing of a received license template at a distributor, according to an embodiment of the invention.

FIG. 13 is a block diagram illustrating the computing context of the invention.

### DETAILED DESCRIPTION OF THE INVENTION

A preferred embodiment of the present invention is now described with reference to the figures, where like reference numbers indicate identical or functionally similar elements. Also, in the figures, the left-most digit of each reference number corresponds to the figure in which the reference number is first used. While specific configurations and arrangements are discussed, it should be understood that this is done for illustrative purposes only. A person skilled in the relevant art will recognize that other configurations and arrangements can be used without departing from the spirit and scope of the invention. It will also be apparent to a person skilled in the relevant art that this invention can also be employed in a variety of other systems and applications.

### I. INTRODUCTION

The invention described herein is a system and method for the issuance of software licenses through a tiered structure, whereby a software license is issued from a software developer to an end user through one or more intermediate layers of distribution. The system and method for doing so enforces a predefined security policy. In an embodiment of the invention, the security policy is defined by the security developer. The security policy may, for example, address who may use the software package, how many users there may be, an expiration date for use of the software, and/or specific features of the software package that may or may not be used by a particular user. The software developer first issues a license template. The next intermediate layer of distribution may be represented by a software distributor, who “fills in” one or more fields of the license template. Any such modification of the software license template must be in accordance with the security policy. In the final transaction, a final distributor transmits a completed software license to a user. At no time can an intermediate distributor issue a license or template that is less restrictive than what is dictated by the security policy, or what is articulated in the received template.

The invention can be implemented as software, firmware, hardware, or any combination thereof.

### II. TOPOLOGIES

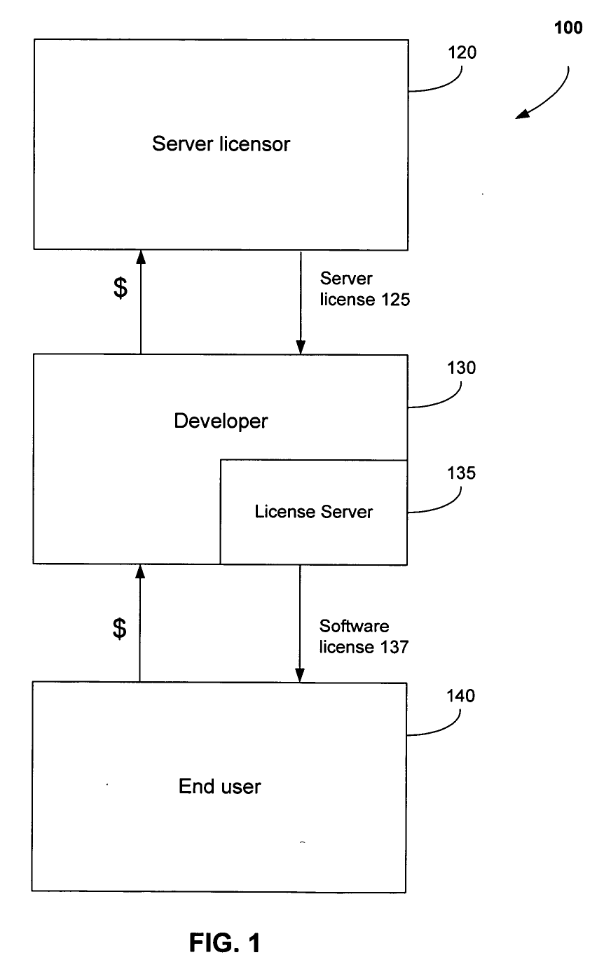

An embodiment of the invention is illustrated generally in FIG. 1. A software developer 130 is shown having a license server 135. License server 135, and any server described herein, may be a dedicated hardware appliance or programmed computer for issuing a software license 137. Alternatively, license server 135, and any server described herein, may be viewed (and implemented) as software that runs on a programmable computing platform.

Software license 137 is sent to end user 140. Generally, a software license is data denoting the usage rights and restrictions placed on a user with respect to the usage of a software package. Such data may be in the form of a file or other data structure. Receipt of such a license permits the recipient to use the software program according to the constraints specified in the license. Software license 137 may, in some circumstances, be sent to end user 140 in response to a request from end user 140. Note that in the illustrated embodiment, developer 130 uses license server 135 only after having received a separate license to use the server 135. This separate license is indicated as server license 125, and is passed to developer 130 from a server licensor 120. Also, server license 125 is passed from server licensor 120 to developer 130 in exchange for compensation, such as a monetary payment. Likewise, software license 137 is sent to end user 140 from developer 130 in exchange for compensation.

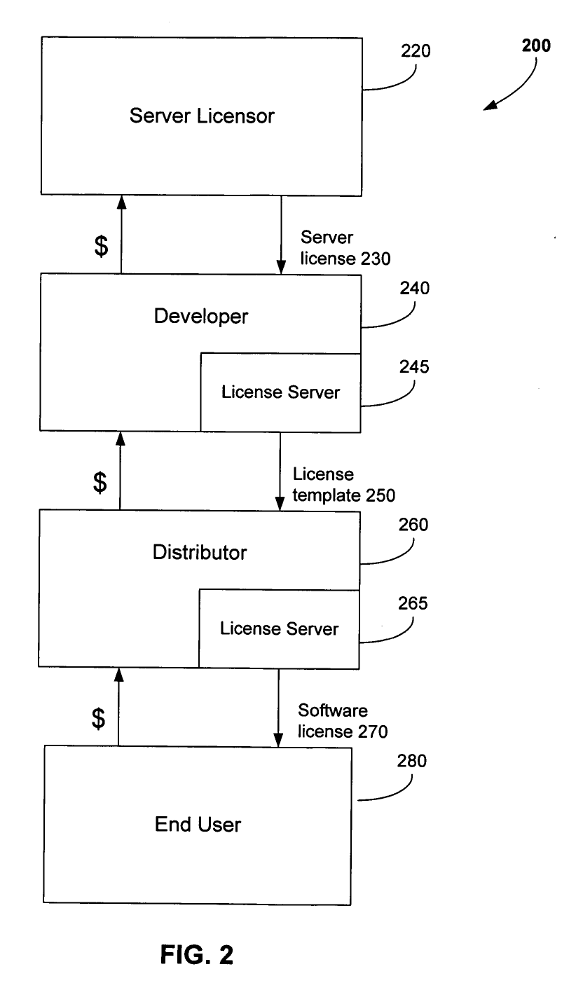

An alternative topology for the distribution of a software license is illustrated in FIG. 2. Here, the software developer 240 includes a license server 245. License server 245 sends license template 250 to a distributor 260. Distributor 260 has a license server 265. License server 265 receives license template 250 and generates a software license 270 on the basis of the acquired license template 250. Software license 270 is then passed on to end user 280.

As before, note that in this embodiment of the invention, the developer 240 operates a license server 245 after having received a separate server license 230 from a server licensor 220. Note also that, as before, compensation is transferred between parties as part of the transactions. Here, end user 280 compensates distributor 260 for software license 270. In addition, distributor 260 compensates developer 240 for license template 250. Finally, developer 240 compensates server licensor 220 in exchange for having received server license 230.

Also, a license template such as license template 250 does not represent a complete license. In an embodiment of the invention, a complete, usable license is not produced by any layer of the topology except for the final distribution layer. In FIG. 2, that distribution layer is represented by distributor 260 and license server 265. Software license 270 is complete in that all conditions for the use of the software package are specified in software license 270. In contrast, license template 250, passed from developer 240 to distributor 260, is incomplete in the sense that not all conditions for the license are articulated in the license template 250. Responsibility for final completion of the license belongs to the final distributor, here distributor 260. Further, any constraints on the user, as stated in both license template 250 and/or software license 270, must be in accordance with the security policy. In an embodiment of the invention, the security policy is dictated by developer 240. Any conditions or restrictions that are specified in license template 250 must be in accordance with this policy. Such conditions or restrictions, when placed in license template 250 are referred to herein as constraint information. Moreover, any constraint information added to the software license template 250 by distributor 260 in generating software license 270 must also be in accordance with that security policy.

For example, the security policy may dictate that the software being licensed not be used after Jan. 1, 2006. Such a restriction may be specified in license template 250. Alternatively, that particular restriction may not be addressed at all in license template 250. In either event, the software license ultimately generated by distributor 260 and license server 265 may state that the software package cannot be used after Jan. 1, 2006. Alternatively, the software license 270 may state that the software package may not be used after Jun. 1, 2005. In this way, the software license 270 may be more restrictive than the security policy. If this particular restriction is not specified in license template 250, license server 265 may complete software license 270, articulating that the software package not be used after Jun. 1, 2005. Alternatively, if license template 250 states that the software package is not to be used after Jan. 1, 2006, license server 265 may adjust that restriction to say that the software package may not be used after Jun. 1, 2005. Hence, the ultimate software license 270 may be more restrictive than the security policy, but it cannot generally be less restrictive than the security policy.

An example of a license template, such as template 250 sent from developer 240 to distributor 260, is shown below:

```
- <FullLicense>
  - <AuthorizedLicense>
    <LicensorName>Acme, Inc.</LicensorName>
    - <Template>
      <templateName>ValuableProduct</templateName>
      <featureName>sample</featureName>
      <featureVersion>1.0</featureVersion>
      <licenseVersion>10</licenseVersion>
      <licenseModel>0</licenseModel>
      <clientServerLockMode>0</clientServerLockMode>
      <clockTamperFlag>1</clockTamperFlag>
      <keyLifeUnits>0</keyLifeUnits>
      <keyLifeTime>5</keyLifeTime>
      <localRequestLockCriteriaFlag>0<
        /localRequestLockCriteriaFlag>
      <localRequestLockCriteria>0x4:0x0:1
        </localRequestLockCriteria>
    </Template>
    - <LicenseTerms>
      <Licensee>Software Distributing, Inc.</Licensee>
      <NumberOfKeys>1000</NumberOfKeys>
      <canDistribute>1</canDistribute>
      <canResell>1</canResell>
      <LockCode>0x2ff - 0x123456789abcd
        ef0fedcba9876543210</LockCode>
    </LicenseTerms>
    - <Authorization>
      <PublicKey>0123456789abcdef012345
        6789abcdef0123456789abcdef...</PublicKey>
      <Signature>11111111111111111111111111
        1111111111111111111111...</Signature>
    </Authorization>
  </AuthorizedLicense>
</FullLicense>
```

Note that the above license template identifies the sender, the publisher Acme, Inc., and the recipient, Software Distributing, Inc. Under the license terms, Software Distributing is authorized to distribute (“canDistribute”) and resell (“canResell”), and can license as many as 1000 ultimate licensees (“NumberOfKeys”), either directly or via one or more lower level distributor(s). The above license template also includes a digital signature, for purposes of authenticating the template to the recipient, Software Distributing, Inc.

The following illustrates an example of a partially completed license template based on the above template, as might be sent from the distributor to another distributor, such as an on-line store:

```
- </FullLicense>
  - <AuthorizedLicense>
      <LicensorName>Acme, Inc.</LicensorName>
    - <Template>
        <templateName>ValuableProduct</templateName>
        <featureName>sample</featureName>
        <featureVersion>1.0</featureVersion>
        <licenseVersion>10</licenseVersion>
        <licenseModel>0</licenseModel>
        <clientServerLockMode>0</clientServerLockMode>
        <clockTamperFlag>1</clockTamperFlag>
        <keyLifeUnits>0</keyLifeUnits>
        <keyLifeTime>5</keyLifeTime>
        <localRequestLockCriteriaFlag>0
          </localRequestLockCriteriaFlag>
        <localRequestLockCriteria>0x4:0x0:1
          </localRequestLockCriteria>
    </Template>
  - <LicenseTerms>
    <Licensee>Software Distributing, Inc.</Licensee>
    <NumberOfKeys>1000</NumberOfKeys>
    <canDistribute>1</canDistribute>
    <canResell>1</canResell>
    <LockCode>0x2ff-0x123456789ab
      cdef0fedcba9876543210</LockCode>
  </LicenseTerms>
  - <Authorization>
    <PublicKey>0123456789abcdef01234567
      89abcdef0123456789abcdef...</PublicKey>
    <Signature>1111111111111111111111111111
      11111111111111111111...</Signature>
  </Authorization>
  </AuthorizedLicense>
  - <AuthorizedLicense>
    <LicensorName>Software Distributing, Inc.
      </LicensorName>
    - <Template>
      <templateName>ValuableProduct
        <templateName>
      <startDate>2005-01-01</startDate>
      <endDate>2008-12-31</endDate>
      <numberOfKeys>5</numberOfKeys>
      <isCommuter>1</isCommuter>
      <commuterMaxCheckoutDays>60
        </commuterMaxCheckoutDays>
      <gracePeriodFlag>1</gracePeriodFlag>
      <gracePeriodCalendarDays>2
        </gracePeriodCalendarDays>
      <gracePeriodElapsedHours>20
        </gracePeriodElapsedHours>
    </Template>
    - <LicenseTerms>
      <Licensee>Online Store, Inc.</Licensee>
      <NumberOfKeys>100</NumberOfKeys>
      <canDistribute>0</canDistribute>
      <canResell>1</canResell>
      <LockCode>0x1f - 0x0102030405060708090a
        0b0c0d0e0f00</LockCode>
    </LicenseTerms>
    - <Authorization>
      <PublicKey>000102030405060708090a0b0
        c0d0e0f0001020304
        050607...</PublicKey>
      <Signature>2222222222222222222
        222222222222222222222
        22222222...</Signature>
    </Authorization>
</AuthorizedLicense>
  </FullLicense>
```

This template includes the information from the first template. It also identifies the sender, Software Distributing, Inc., and the recipient, OnLine Store, Inc. This license is more restrictive than the previous template. It indicates that OnLine Store can resell, but cannot otherwise distribute, and can grant no more that 100 licenses, for example. This gives OnLine Store the freedom to sell no more than 100 software packages. The above template also specifies that no more than five software packages can be sold to any given customer. Also, an expiration date of Dec. 31, 2008 is now specified, with a two-day grace period. This template also includes a digital signature for authentication of the sender.

The following illustrates an example of a completed license, as might be sent to an end user 280:

```
- <FullLicense>
  - <AuthorizedLicense>
    <LicensorName>Acme, Inc.</LicensorName>
    - <Template>
        <templateName>ValuableProduct</templateName>
      <featureName>sample</featureName>
      <featureVersion>1.0</featureVersion>
      <licenseVersion>10</licenseVersion>
      <licenseModel>0</licenseModel>
      <clientServerLockMode>0</clientServerLockMode>
      <clockTamperFlag>1</clockTamperFlag>
      <keyLifeUnits>0</keyLifeUnits>
      <keyLifeTime>5</keyLifeTime>
      <localRequestLockCriteriaFlag>0
          </localRequestLockCriteriaFlag>
      <localRequestLockCriteria>0x4:0x0:1
          </localRequestLockCriteria>
    </Template>
    - <LicenseTerms>
      <Licensee>Software Distributing, Inc.</Licensee>
      <NumberOfKeys>1000</NumberOfKeys>
      <canDistribute>1</canDistribute>
      <canResell>1</canResell>
      <LockCode>0x2ff - 0x123456789abcdef0
        fedcba9876543210</LockCode>
      </LicenseTerms>
      - <Authorization>
        <PublicKey>0123456789abcdef01234567
          89abcdef0123456789abcdef...</PublicKey>
        <Signature>111111111111111111111
          11111111111111111111111
          1111...</Signature>
      </Authorization>
    </AuthorizedLicense>
    - <AuthorizedLicense>
      <LicensorName>Software Distributing, Inc.</LicensorName>
      - <Template>
        <templateName>ValuableProduct</templateName>
        <startDate>2005-01-01</startDate>
        <endDate>2008-12-31</endDate>
        <numberOfKeys>5</numberOfKeys>
        <isCommuter>1</isCommuter>
        <commuterMaxCheckoutDays>60
          </commuterMaxCheckoutDays>
        <gracePeriodFlag>1</gracePeriodFlag>
        <gracePeriodCalendarDays>2</gracePeriodCalendarDays>
        <gracePeriodElapsedHours>20</gracePeriodElapsedHours>
      </Template>
      - <LicenseTerms>
        <Licensee>Online Store, Inc.</Licensee>
        <NumberOfKeys>100</NumberOfKeys>
        <canDistribute>0</canDistribute>
        <canResell>1</canResell>
        <LockCode>0x1f-0x0102030405060708090a
          0b0c0d0e0f00</LockCode>
      </LicenseTerms>
      - <Authorization>
        <PublicKey>000102030405060708090a0b0c0d
          0e0f0001020304050607...</PublicKey>
        <Signature>22222222222222222222222
          2222222222222222222222222...</Signature>
      </Authorization>
    </AuthorizedLicense>
    - <AuthorizedLicense>
      <LicensorName>Online Store, Inc.</LicensorName>
      - <LicenseTerms>
        <Licensee>John Doe</Licensee>
        <startDate>2005-11-11</startDate>
        <endDate>2006-12-31</endDate>
        <NumberOfKeys>3</NumberOfKeys>
        <canDistribute>0</canDistribute>
        <canResell>0</canResell>
        <LockCode>0x04-0x00112233445566778899
          aabbccddeeff</LockCode>
      </LicenseTerms>
      - <Authorization>
        <PublicKey>00112233445566778899aabbcc
          ddeeff0011223344556677...</PublicKey>
        <Signature>3333333333333333333333
          33333333333333333333333333...</Signature>
    </Authorization>
  </AuthorizedLicense>
</FullLicense>
```

This completed license template includes the information from the second template above. It identifies the immediate licensor, OnLine Store, Inc., and the licensee, John Doe. This license is more restrictive than the previous template, e.g., the license expires at the end of 2006 instead of 2008, and Doe can neither resell nor distribute. Also, the license is limited to three users. Again, a digital signature is included to allow authentication of OnLine Store.

Note that in the examples above, each template includes information from the predecessor template, and each licensor adds its own license information at the end. In alternative embodiments of the invention, a license template may not include information from the predecessor template. A distributor, for example, may not want to reveal the terms of its license.

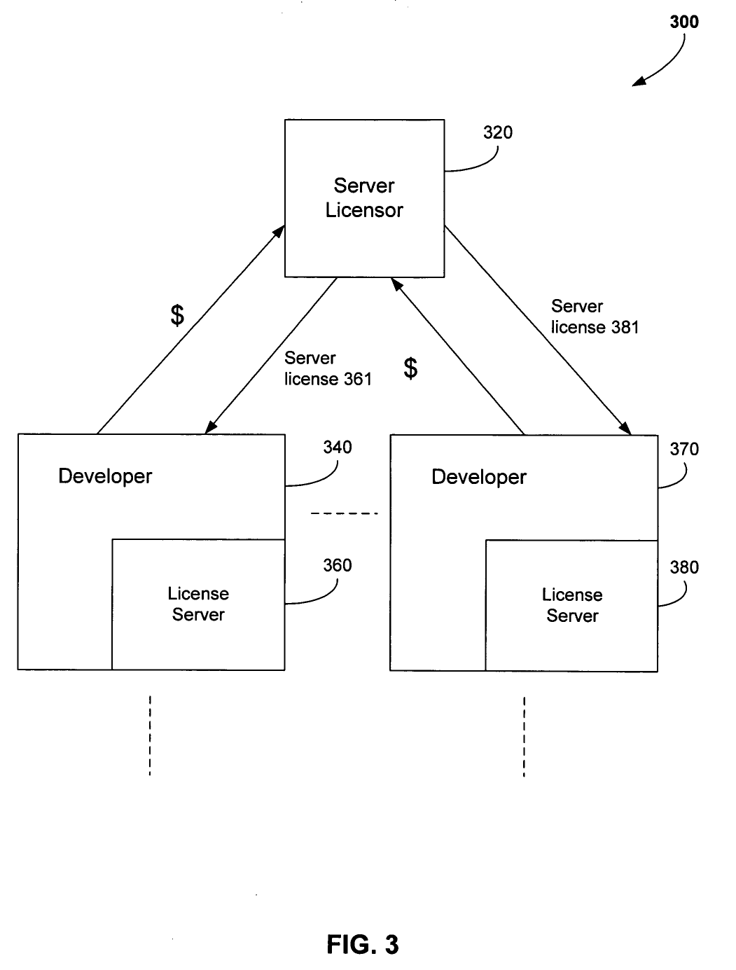

FIG. 3 illustrates a portion of a software license distribution topology in which a server licensor 320 deals with a plurality of developers, including developers 340 and 370. Here, developer 340 includes a license server 360, while developer 370 includes a license server 380. Server licensor 320 is shown sending a server license 361 to developer 340, and a server license 381 to developer 370. While only two developers are illustrated here, it should be understood that any given server licensor may deal with two or more developers. Any of the illustrated developers may subsequently generate a license template for distribution to a subsequent distributor, or may generate a completed software license for distribution to an end user.

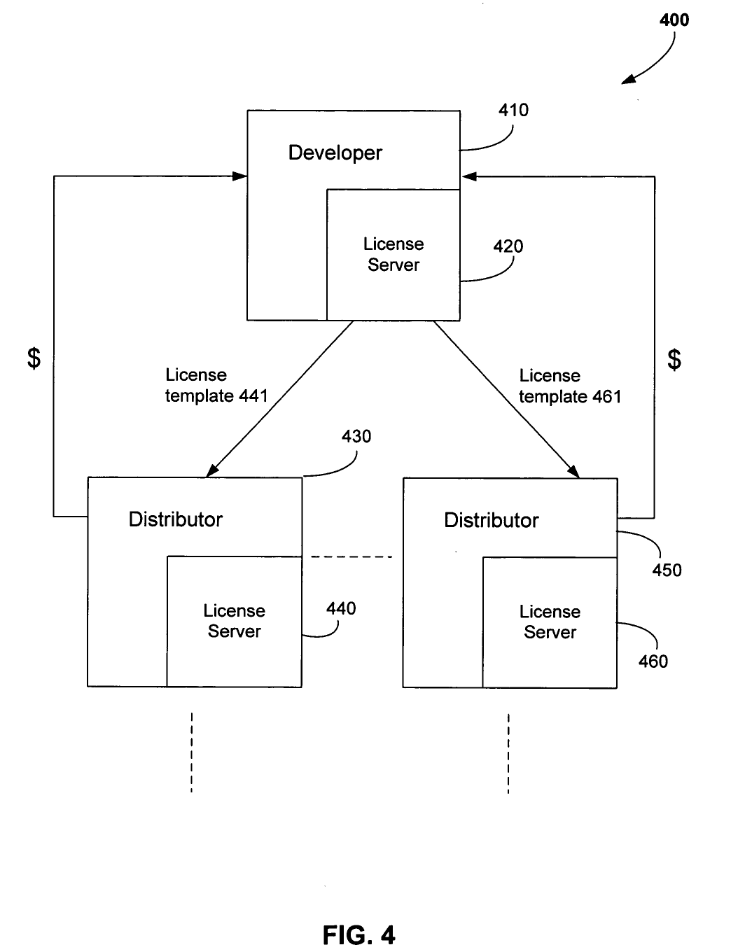

FIG. 4 illustrates another alternative software license distribution topology, in which a developer 410 sends license templates to a plurality of distributors. Here, developer 410 includes a license server 420, which issues license templates 441 and 461 to distributors 430 and 450. Distributor 430 includes a license server 440, which processes the acquired license template 441 and may generate a subsequent license template for transfer to a subsequent distributor or, alternatively, may generate a completed software license. Similarly, license server 460 and distributor 450 may process the acquired license template 461 and generate a subsequent template for transfer to a subsequent distributor, or may generate a completed software license for transfer to an end user.

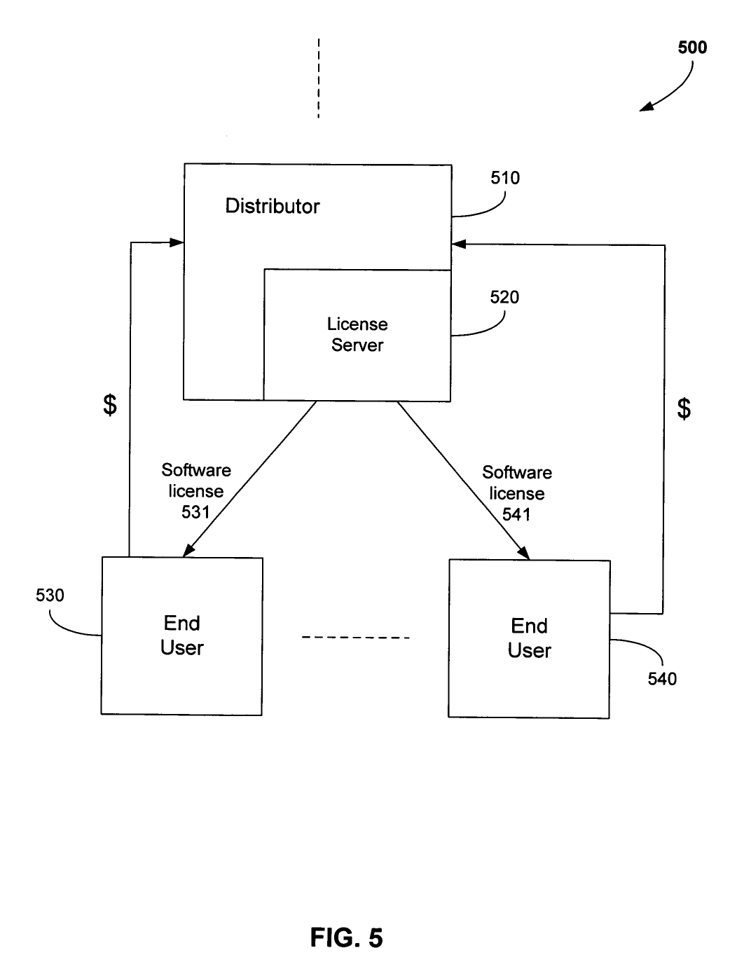

Another exemplary portion of a software license distribution topology is illustrated in FIG. 5. Here, a distributor 510 includes a license server 520. License server 520 generates software licenses 531 and 541 for distribution to end users 530 and 540 respectively. While two end users are shown in communication with distributor 510, it should be understood that any given distributor may send software licenses to more than two end users.

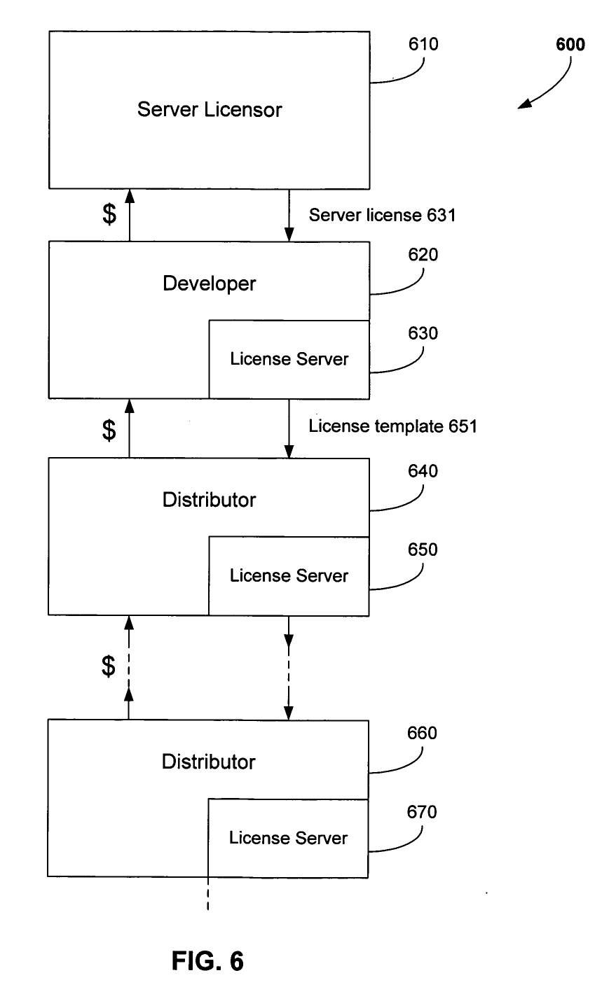

FIG. 6 illustrates a software license distribution topology where developer 620 includes a license server 630 that generates license templates for transfer to a series of distributors. Here, license server 630 generates a license template 651 and transfers template 651 to distributor 640. Distributor 640 includes a license server 650. License server 650 generates a license template (not illustrated) for transfer to a subsequent distributor. This sequence can continue until a license template is acquired by distributor 660 and processed by its license server 670. Based on the acquired license template, license server 670 may generate a further license template for transfer to a subsequent distributor, or it may generate a software license for distribution to an end user.

As discussed previously, a developer may operate a license server after having received a separate server license from a server licensor. In FIG. 6, developer 620 receives a server license 631 from server licensor 610. This enables developer 620 to operate license server 630.

Note that the invention can be implemented in any of the license distribution topologies of FIGS. 1-6, or in any combination of these illustrated topologies. The illustrated systems are intended to be exemplary embodiments, and do not limit the scope of the invention.

### III. METHOD

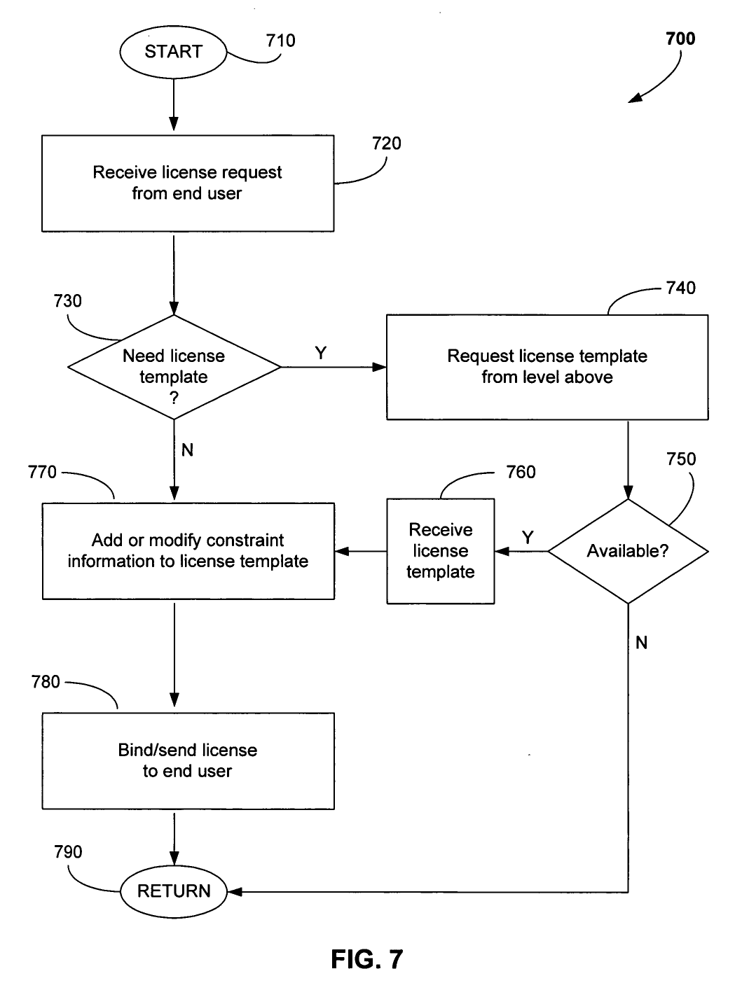

The processing of an embodiment of the invention is illustrated in FIG. 7. This figure illustrates the generation of a software license on the basis of a received license template, as performed by a license server. The process starts at step 710. At step 720, the license server receives a license request from an end user or a party representing the end user, such as the user's employer. At step 730, the license server determines whether it has a license template, i.e., the license server determines whether it has a license template that can be completed for purposes of generating a software license. If the license server has no template but needs one to convert to a software license, then the process continues at step 740. Here, the license server requests a license template from the level above in the distribution hierarchy. The license server may then request a license template from either the distributor or the software developer which supplies license templates to this license server.

In step 750, a determination is made as to whether the level above has an available licensed template that can be transferred to the current license server. If the server at the level above has a template available, the template is transferred, and in step 760, the current license server receives the license template from the level above. Such a template is referred to herein as an acquired license template. In step 770, constraint information may be added to the acquired license template, as described above. Note that in some implementations, constraint information may have already been added to the acquired license template prior to this point, e.g., at a previous level of distribution. Therefore, all necessary constraint information may already be present prior to step 770, making step 770 unnecessary. Alternatively, new constraint information may be added in step 770. Alternatively, existing constraint information already in the acquired license template may be modified to further constrain the conditions of use for the product being licensed. Any modification to the acquired license template in step 770 results in a modified license template. If and when the license server completes the template, the resulting modified license template represents the completed license.

If, in step 730, it is determined that the current license server has a previously acquired license template in hand, then the license server does not need to obtain a license template. Therefore, the process would continue at step 770. At step 780, the completed license is bound and sent to the end user. The process of binding and sending a license to an end user is described in greater detail below. The process concludes at step 790.

Note that when the license server requests a license template from the level above in step 740, the license server at the level above may not have any license templates available. In this case, the license server at the level above would then ask for a license template from the next successive level above. This process would continue until an available license template is found. At that point, the available license template would be sent down (and possibly modified at one or more intervening levels) until reaching the license server that initially requested the license template. If, in step 750, it is determined that there are no license templates available at any level above the requesting license server, then no license can be generated, and the process terminates. In an embodiment of the invention, a suitable error message would be sent to the requesting end user.

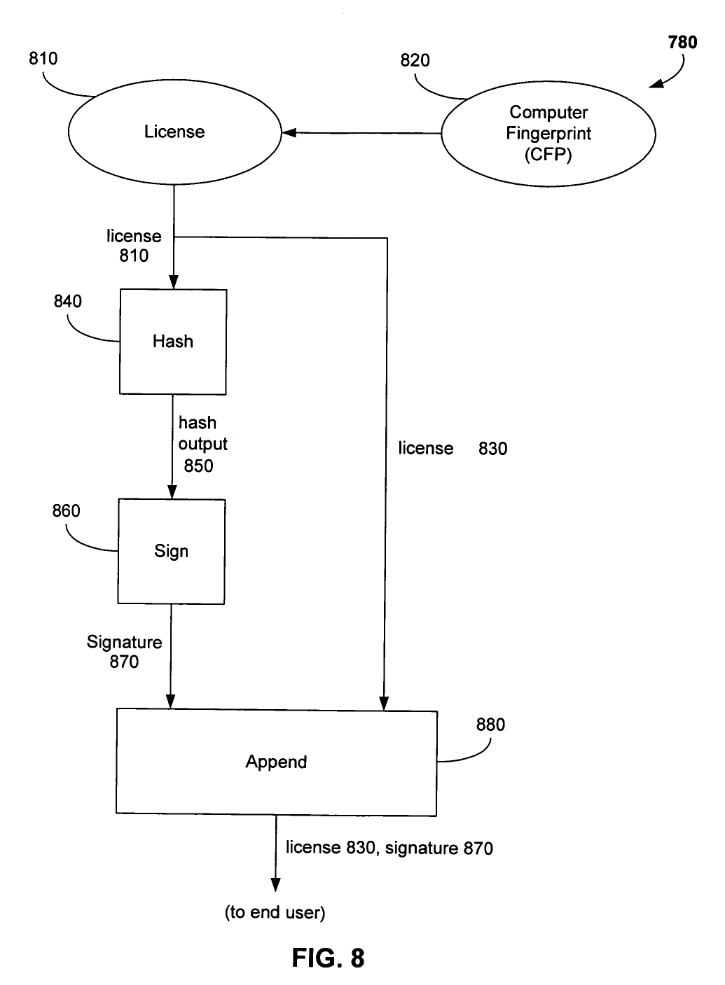

Step 780, the step of binding and sending a license to an end user, is illustrated in greater detail in FIG. 8. Here, a license template has been acquired by the license server from a level above, and possibly modified. Information identifying the computer of the end user, shown here as computer finger print (CFP) 820, is entered into license 810. The CFP can be a number or string derived from one or more unique components of a computer (e.g., network card LAN address, or hard disk serial number). Here, the CFP would be derived from one or more components of the recipient computer of the end user. This component value may be used directly as the CFP. Alternatively, the CFP may be a combination of multiple values and may be the output of a transformation of such values (e.g., a hash or encryption function). Once CFP 820 is entered into license 810, the license 810 is then input to a hash function 840. Hash function 840 can be any open source hash function, such as the secure hash algorithm SHA-1. In an alternative embodiment of the invention, a proprietary hash function can also be used. Hash output 850 is then entered into a signing function 860. This results in a signature 870. The signature 870 is then appended to the license 810 at step 880. The result is license 810 appended with a signature 870. This data is then forwarded to the requesting end user. Hashing and signing functions 840 and 860, respectively, may be implemented in software or hardware, or in any combination thereof.

Note that the signature function 860 can be performed, in an embodiment of the invention, using public key photography. In this case, the signing function 860 would be performed using the private component of a public key pair. As will be described below, the end user would then apply the public component of that public key pair, for purposes of authenticating the license server.

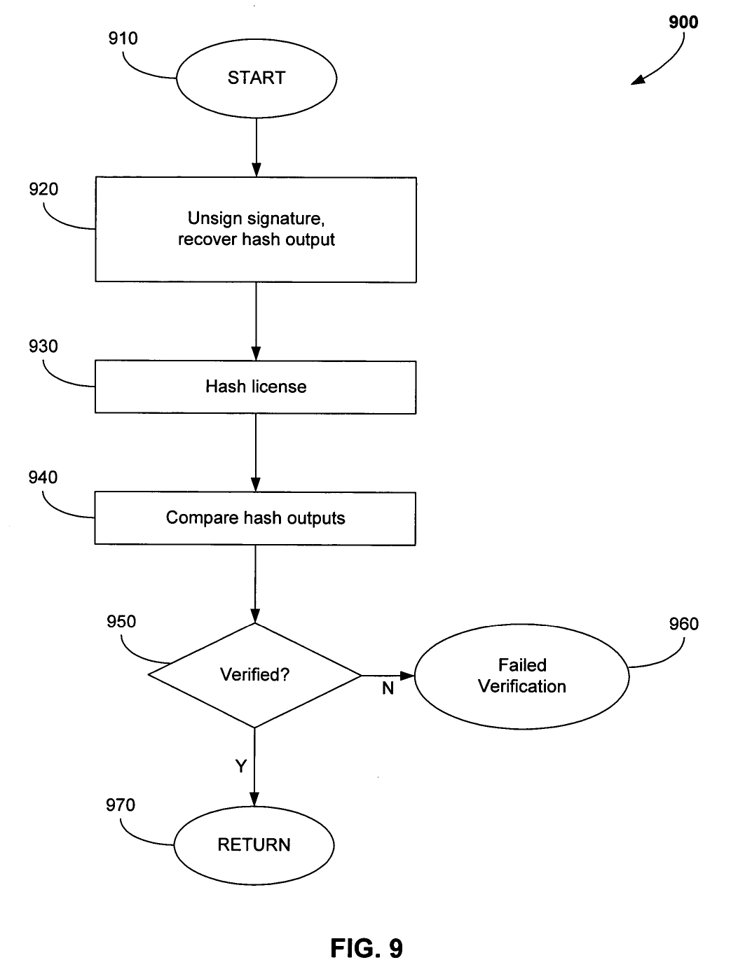

FIG. 9 illustrates processing that may be performed at the end user after having received license 830 and signature 870. The process begins at step 910. In step 920, the end user unsigns the received signature, and recovers the hash output 850. In step 930, the end user performs the same hash function as used above in step 840, to hash license 830. The hash outputs that were generated in steps 920 and 930 are then compared in step 940. In step 950, a determination is made as to whether the hash outputs match. If so, the signature has been verified, and the process concludes at step 970. License 830 can then be used by the end user. If, in step 950, the hash outputs fail to match, then a state of failed verification 960 has been reached. In an embodiment of the invention, an appropriate error message is generated for the end user.

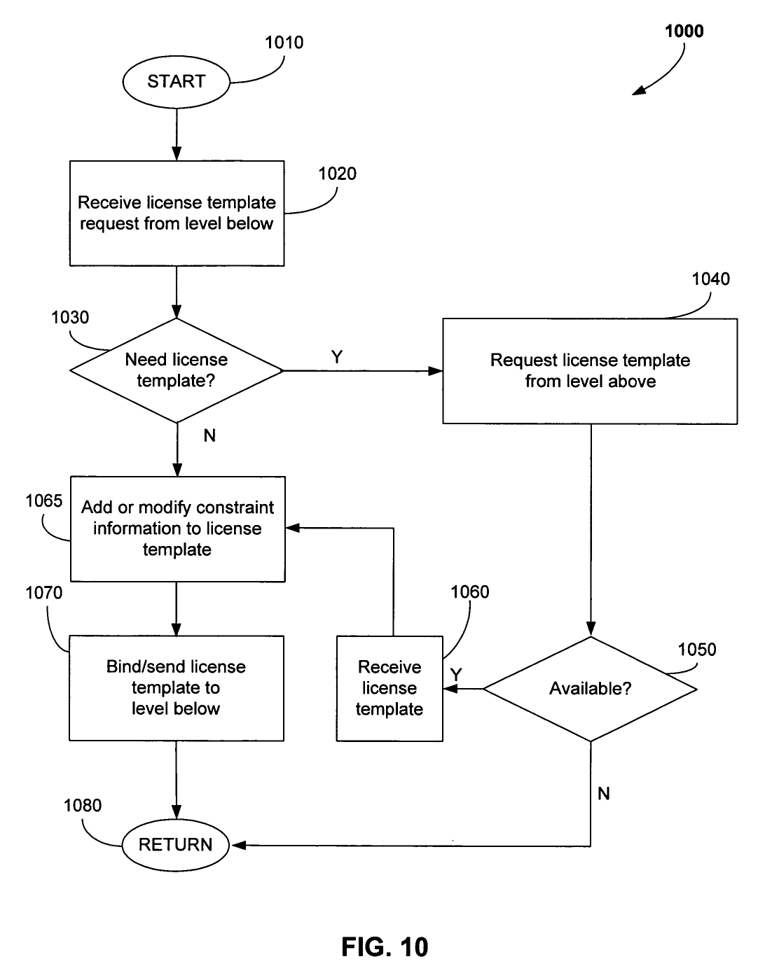

FIG. 10 illustrates the processing performed at a license server in response to a request for a license template from a license server at a level below. The process begins at step 1010. In step 1020, the license server receives a license template request from the level below. In step 1030, the license server determines whether it needs a license template. If the license server does not need a license template, and it has a previously acquired license template available, then the process continues at step 1065. Note that in some implementations, constraint information may be added to the license template in step 1065. Alternatively, in this step, existing constraint information already in the license template may be modified to further constrain the conditions of use for the product being licensed. Any such modification to the acquired license template results in a modified license template. In other implementations of the invention, no modifications are made to the template in step 1065. The license template is bound and sent to the requesting level below in step 1070.

If, in step 1030, the determination is made that the license server has no available license template and therefore needs a template, then the process continues at step 1040. Here, the license server requests a license template from the level above. In step 1050, a determination is made as to whether a license template is available to be sent to the license server. If so, a license template is sent from above to the license server, so that in step 1060, the license server acquires a license template. Again, in some implementations, constraint information may be added to the acquired license template, or existing constraint information may be modified in step 1065. In step 1070, the acquired and possibly modified license template is bound and sent to the level below. The process concludes at step 1080.

If, in step 1050, it is determined that there are no license templates are available from levels above, then the license server cannot send a license template to the requesting level below, and the process concludes. Note that, as discussed above with respect to FIG. 7, a request for a license template from the level above (step 1040) results in processing at the level above as to whether a license template is available at that level. If not, a license template will be sought from the next level above. The process will continue until either a license template is found, or a determination is made that there are no license templates available.

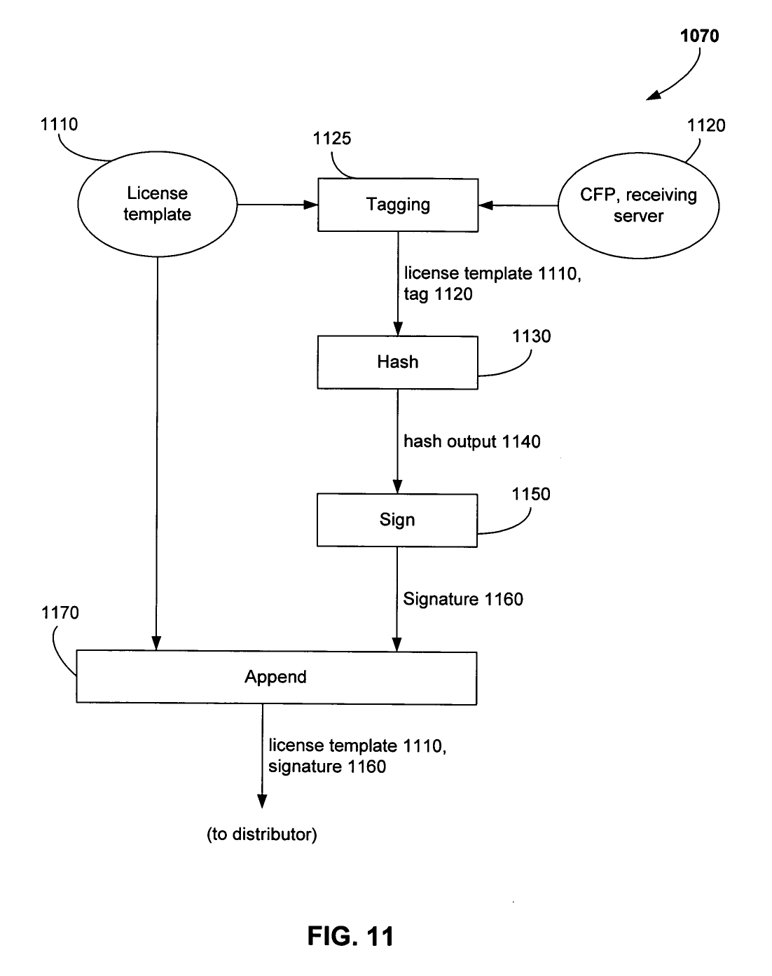

Step 1070, the step of binding and sending a license template to the requesting level below is illustrated in greater detail in FIG. 11. Here, a license template 1110 is combined with CFP 1120. CFP 1120 is associated with the computer of the server that will next receive the license template 1110. License template 1110 and CFP 1120 are combined in tagging function 1125. This results in license template 1110 in combination with the CFP 1120, which is shown here in the form of tag 1120. This information in aggregate is entered into hash function 1130. Hash function 1130 can be any open source hash function, or alternatively, may be a proprietary hash function. The output 1140 from hash operation 1130 is then entered into signature function 1150. This results in a signature 1160. Signature 1160 is then appended to license template 1110 in step 1170. This data is then sent on to the distributor whose license server requested the template 1110.

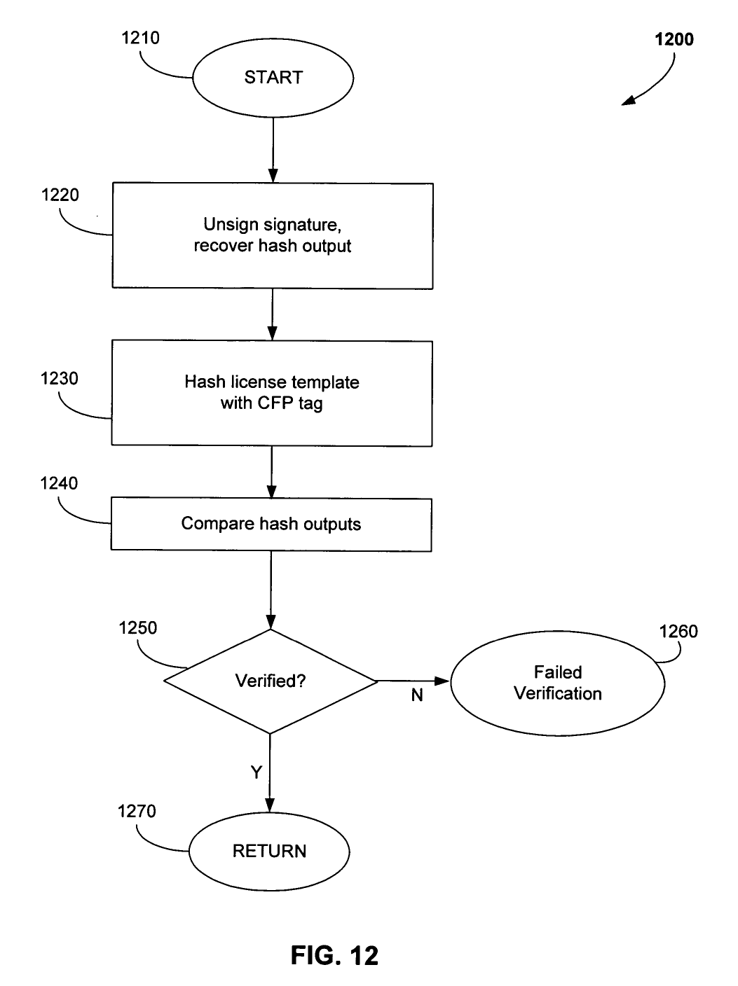

The processing performed at the requesting license server in response to receipt of the template is illustrated in FIG. 12. The process begins at step 1210. In step 1220, the receiving license server unsigns the received signature, to recover hash output 1140. In step 1230, the license server hashes license template 1110 and tag 1120. In step 1240, the license server compares the hash outputs from steps 1220 and 1230. In step 1250, a determination is made as to whether the hash outputs match. If so, then the signature 1160 has been verified, and the process concludes at step 1270. At this point, the license server can use the received license template. If the hash outputs from step 1220 and 1230 fail to match, then verification fails at state 1260.

### IV. COMPUTING CONTEXT

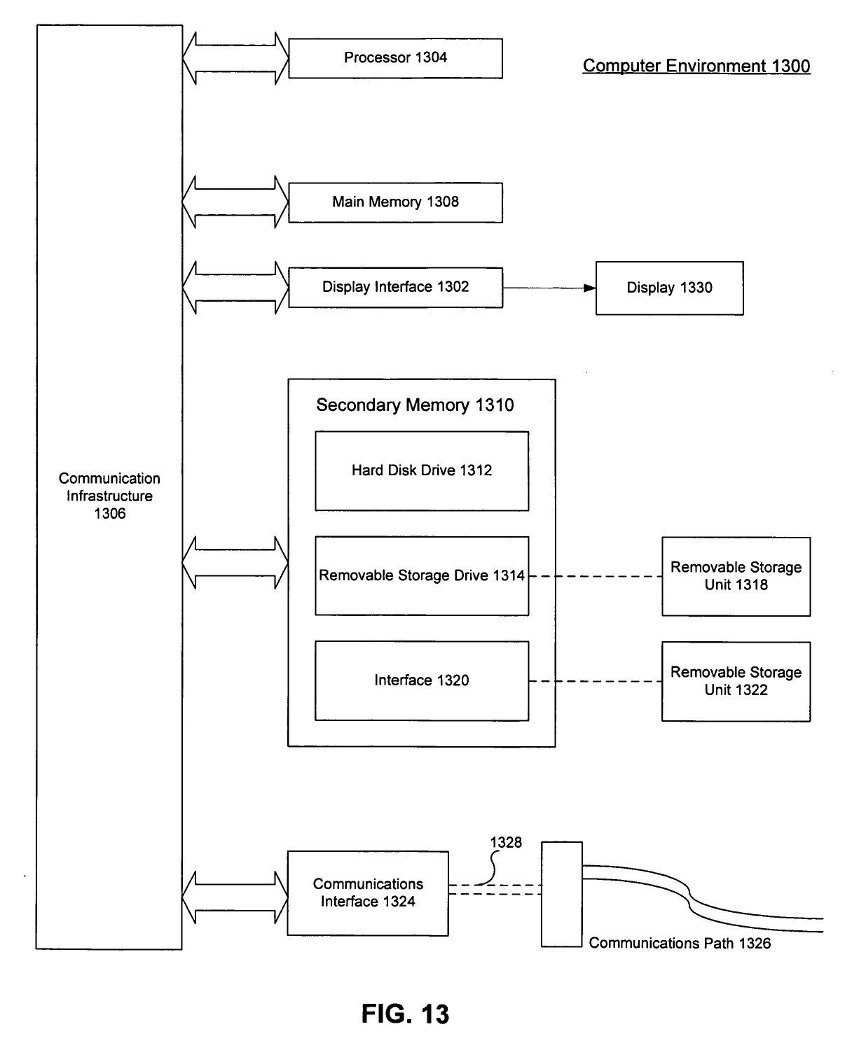

The present invention may be implemented using hardware, software or a combination thereof and may be implemented in one or more computer systems or other processing systems. In one embodiment, the invention may comprise one or more computer systems capable of carrying out the functionality described herein. An example of a computer system 1300 is shown in FIG. 13. Such a computer system may be used to implement any of the servers described herein. The computer system 1300 may include one or more processors, such as processor 1304. The processor 1304 may be connected to a communication infrastructure 1306 (e.g., a communications bus or network). Various software embodiments are described in terms of this exemplary computer system. After reading this description, it will become apparent to a person skilled in the relevant art(s) how to implement the invention using other computer systems and/or computer architectures.

Computer system 1300 may include a display interface 1302 that may forward graphics, text, and other data from the communication infrastructure 1306 (or from a frame buffer not shown) for display on the display unit 1330.

Computer system 1300 may also include a main memory 1308, preferably random access memory (RAM), and may also include a secondary memory 1310. The secondary memory 1310 may include, for example, a hard disk drive 1312 and/or a removable storage drive 1314, representing a floppy disk drive, a magnetic tape drive, an optical disk drive, etc, but which is not limited thereto. The removable storage drive 1314 may read from and/or write to a removable storage unit 1318 in a well known manner. Removable storage unit 1318, may represent a floppy disk, magnetic tape, optical disk, etc. which may be read by and written to by removable storage drive 1314. As will be appreciated, the removable storage unit 1318 may include a computer usable storage medium having stored therein computer software and/or data.

In alternative embodiments, secondary memory 1310 may include other similar means for allowing computer programs or other instructions to be loaded into computer system 1300. Such means may include, for example, a removable storage unit 1322 and an interface 1320. Examples of such may include, but are not limited to, a removable memory chip (such as an EPROM, or PROM) and associated socket, and/or other removable storage units 1322 and interfaces 1320 that may allow software and data to be transferred from the removable storage unit 1322 to computer system 1300.

Computer system 1300 may also include one or more communications interfaces 1324. Communications interface 1324 may allow software and data to be transferred between computer system 1300 and external devices. Examples of communications interface 1324 may include, but are not limited to, a modem, a network interface (such as an Ethernet card), a communications port, a PCMCIA slot and card, etc. Software and data transferred via communications interface 1324 are in the form of signals 1328 which may be, for example, electronic, electromagnetic, optical or other signals capable of being received by communications interface 1324. These signals 1328 may be provided to communications interface 1324 via a communications path (i.e., channel) 1326. This channel 1326 may carry signals 1328 and may be implemented using wire or cable, fiber optics, a phone line, a cellular phone link, an RF link and/or other communications channels. Signals 1328 may represent (but are not limited to) an incoming request for a license or a request for a license template, or an incoming license or acquired license template. Signals 1328 may also represent an outgoing license or license template, possibly modified relative to an acquired license template, or an outgoing request for a license or license template.

In this document, the terms “computer program medium” and “computer usable medium” are used to generally refer to media such as, but not limited to, removable storage drive 1314, a hard disk installed in hard disk drive 1312, and signals 1328. These computer program media are means for providing software to computer system 1300.

Computer programs (also called computer control logic) may be stored in main memory 1308 and/or secondary memory 1310. Computer programs may also be received via communications interface 1324. Such computer programs, when executed, enable the computer system 1300 to perform the features of the present invention as discussed herein. In particular, the computer programs, when executed, may enable the processor 1304 to perform the present invention in accordance with the above-described embodiments. Accordingly, such computer programs represent controllers of the computer system 1300.

In an embodiment where the invention is implemented using software, the software may be stored in a computer program product and loaded into computer system 1300 using, for example, removable storage drive 1314, hard drive 1312 or communications interface 1324. The control logic (software), when executed by the processor 1304, causes the processor 1304 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s). As discussed above, the invention can be implemented using any combination of hardware, firmware and software.

### V. CONCLUSION

While some embodiments of the present invention have been described above, it should be understood that it has been presented by way of examples only and not meant to limit the invention. It will be understood by those skilled in the art that various changes in form and detail may be made therein without departing from the spirit and scope of the invention as defined in the appended claims. Thus, the breadth and scope of the present invention should not be limited by the above-described exemplary embodiments, but should be defined only in accordance with the following claims and their equivalents.

We claim:

1. A license server, comprising:
means for acquiring a license template from a higher level license server;
means for adding constraint information to said license template in accordance with a security policy, to create a modified license template; and
means for outputting said modified license template.

2. The license server of claim 1, further comprising:
means for receiving a request for a license from a user.

3. The license server of claim 1, wherein said modified license template comprises a license.

4. The license server of claim 3, wherein said means for outputting said modified license template comprises means for sending said license to a user.

5. The license server of claim 1, further comprising means for authenticating said modified license template.

6. The license server of claim 5, wherein said means for authenticating comprises a hashing function.

7. The license server of claim 6, wherein said hashing function comprises a secure hashing function.

8. The license server of claim 6, wherein said hashing function receives a hash input comprising a license and a computer fingerprint of a recipient, and produces a corresponding hash output.

9. The license server of claim 6, wherein said hashing function receives a hash input comprising said license template and a computer fingerprint of a recipient, and produces a corresponding hash output.

10. The license server of claim 6, wherein said means for authenticating further comprises a signature function, which signs an output of said hash function and produces a signature.

11. The license server of claim 1, wherein said means for acquiring a license template comprises means for authenticating said license template.

12. The license server of claim 11, wherein said means for authenticating said license template comprises an unsigning function which unsigns a signature that accompanies said license template.

13. The license server of claim 12, wherein said means for authenticating said license template further comprises a hashing function which hashes said license template and a computer fingerprint, and which produces a hash output for comparison with an output of said unsigning function.

14. The license server of claim 13, wherein said hashing function comprises a secure hashing function.

15. A method of conveying an acquired license template to a recipient, comprising the steps of:
(a) verifying authenticity of the acquired license template;
(b) combining the acquired license template with a computer fingerprint (CFP) of the recipient;
(c) hashing the combination resulting from said step (b) to form a hash output;
(d) signing the hash output to form a signature;
(e) appending the signature with the combination of step (b); and
(f) sending the signature and the combination of step (b) to the recipient.

16. The method of claim 15, wherein said step (a) comprises:
(i) unsigning a signature received with the acquired license template;
(ii) hashing the acquired license template; and
(iii) comparing an output of step (i) with an output of step (ii).

17. The method of claim 15, further comprising:
(g) modifying existing constraint information in the acquired license template,
performed after step (a) and before step (b).

18. The method of claim 15, further comprising:
(g) adding constraint information to the acquired license template, performed after step (a) and before step (b).

19. The method of claim 18, wherein
said step (g) comprises adding sufficient constraint information to the acquired license template, so that the acquired license template becomes a license; and
said step (f) represents sending the signature and the combination of the license and the CFP to the recipient.

20. The method of claim 15, wherein said step (c) comprises securely hashing the combination resulting from said step (b).
